(19) United States
(12) Patent Application Publication
(10) Pub. No.: US 2003/0005057 A1
(43) Pub. Date: Jan. 2, 2003

(54) Computerized systems and methods for acquiring and disseminating process management information

(76) Inventors: Michael Robert LaBlanc, Wilton, NY (US); Leonard Richard Douglas, Burnt Hills, NY (US); Mark Mitchell Kornfein, Latham, NY (US); Mary Clarkeson Phillips, Delmar, NY (US); Octavio Garcia, Clifton Park, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,947

(22) Filed: Jun. 29, 2001

(51) Int. Cl. G06F 15/16

(52) U.S. Cl. 709/206

(57) ABSTRACT

Computerized systems and methods for acquiring and disseminating information using a mail client system including an application operable for generating and incorporating a plurality of messages and one or more message handlers in communication with the application and the mail client system, the one or more message handlers operable for attaching identifying information to each of the plurality of messages. The systems and methods also including a definition operable for translating each of the plurality of messages such that each of the plurality of messages may be understood by the one or more message handlers and a communications network operable for transmitting each of the plurality of messages between the application, the one or more message handlers, and the mail client system.

### BACKGROUND OF INVENTION

The present invention relates generally to computerized systems and methods for assuring process compliance for a wide array of processes and, more specifically, to web-based systems and methods for acquiring and disseminating process management information using an external mail client system.

Businesses utilize a variety of processes in their day-to-day operations. These processes may involve the completion of a number of discrete steps, forming a project. For example, businesses may utilize a variety of processes for bringing new products to market, often collectively referred to as new product introduction (NPI) processes. NPI processes may involve, for example, initial product conception, product design, product manufacture, and post-shipment follow-up. Typically, such processes include a series of tollgates, or go/no-go points. Each tollgate may include a set of activities and each set of activities may include a set of tasks. Typically, such processes also include a series of issues and risks which must be monitored, tracked, and addressed. While NPI and other processes are often very similar, they may be customized based upon the needs of a particular business or the requirements associated with a particular product. As a result, such processes may vary with respect to focus, steps, and nomenclature.

Traditionally, businesses have kept track of the steps comprising a project manually on paper or with the aid of locally-accessible computer programs, such as spreadsheets and project management applications. Such systems and methods, however, have several important limitations. Such systems and methods are not generic and new papers or spreadsheets must be generated, for example, each time a new product is introduced, or when a new business utilizes and existing process. Alternatively, when locally-accessible project management applications are used, information must be transferred from user to user via a computer-readable medium, such as on a diskette. This precludes the simultaneous updating of process-related information. Likewise, it is difficult for a remote user to monitor and track the status of a particular tollgate, activity, task, issue, or risk within the context of a given project.

When a globally-accessible project management application is used, there is a need for systems and methods which allow the application to send messages to and receive messages from a plurality of remote users, check on the availability of and schedule meetings for a plurality of remote users, and assign tasks to a plurality of remote users. There is also a need for systems and methods which perform these functions using an external mail client system. Further, there is a need for systems and methods which allow email imported into or exported out of the project management application to be related to a particular business object or a prior message, i.e. threaded.

### SUMMARY OF INVENTION

The present invention overcomes the above limitations and provides systems and methods for acquiring and disseminating information, such as process management information, using an external mail client system.

In one embodiment, a computerized system for acquiring and disseminating information using a mail client system includes an application operable for generating and incorporating a plurality of messages and one or more message handlers in communication with the application and the mail client system, the one or more message handlers operable for attaching identifying information to each of the plurality of messages. The system also includes a definition operable for translating each of the plurality of messages such that each of the plurality of messages may be understood by the one or more message handlers and a communications network operable for transmitting each of the plurality of messages between the application, the one or more message handlers, and the mail client system.

In another embodiment, a computerized method for acquiring and disseminating information using a mail client system includes generating and receiving a plurality of messages, attaching identifying information to each of the plurality of messages, translating each of the plurality of messages such that each of the plurality of messages may be understood by one or more message handlers, and transmitting each of the plurality of messages between an application, the one or more message handlers, and the mail client system using a communications network.

### BRIEF DESCRIPTION OF DRAWINGS

FIG. 1 is a functional block diagram of one embodiment of a computerized system for acquiring and disseminating process management information using an external mail client system;

FIG. 2 is a flow chart of one embodiment of a computerized method for acquiring and disseminating process management information using an external mail client system;

FIG. 3 is a schematic diagram of one embodiment of a computerized system for acquiring and disseminating process management information using an external mail client system;

FIG. 4 is a functional block diagram of one embodiment of a computer system comprising the system for acquiring and disseminating process management information using an external mail client system; and

FIG. 5 is a functional block diagram of one embodiment of a system architecture for the system for acquiring and disseminating process management information using an external mail client system.

### DETAILED DESCRIPTION

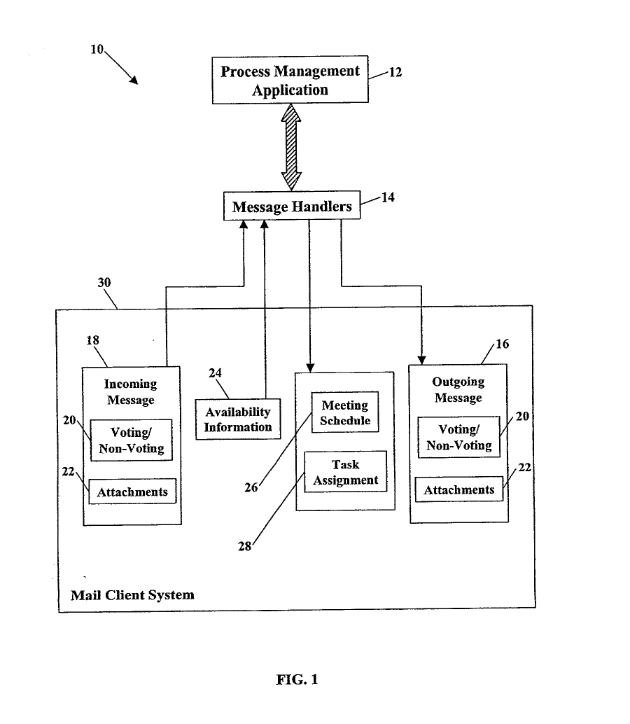

Referring to FIG. 1, in one embodiment, a computerized system 10 for acquiring and disseminating process management information includes a process management application 12 in communication with one or more message handlers 14. The process management application 12 may allow a remote user to log into a globally-accessible system and create and store a plurality of tollgates, activities, tasks, issues, and risks associated with a given project. The globally-accessible system preferably includes a web page. The web page may be secure and may include a plurality of dynamic menus, drop-down lists, links, and the like displayed on a graphical user interface. Through the web page, a project creator, a project leader, a project manager, a team member, an activity or task performer, or any other authorized remote user may view information, submit information, and query the process management application 12. After a set of tollgates, activities, tasks, issues, and risks has been created and stored, the process management application 12 may attach meta-data to the process-related information. The meta-data may include information about the tollgates, activities, tasks, issues, and risks. The meta-data allows the tollgates, activities, tasks, issues, and risks to be searched and identified. For example, the meta-data may be used to search for an issue among one or a plurality of projects, search for a risk among one or a plurality of projects, or identify a project based upon a given issue or risk. Once a tollgate, activity, task, issue, or risk has been searched and identified, the status of the tollgate, activity, task, issue, or risk may be monitored and tracked by a remote user.

The message handlers 14 are operable for sending outgoing messages 16 to and receiving incoming messages 18 from a plurality of remote users. These messages may be voting or non-voting 20 and may, optionally, contain attachments 22. The message handlers 14 are also operable for querying the availability 24 of a plurality of remote users and scheduling meetings 26 for the plurality of remote users. Further, the message handlers 14 are operable for assigning tasks 28 to the plurality of remote users. These messages 16,18, meeting requests 26, and task assignments 28 may be viewed by a remote user in an external mail client system 30, such as Microsoft Outlook (Microsoft Corporation, Redmond, Wash.). For example, meeting requests 26 may be viewed on a recipient's calendar, task assignments 28 may be viewed on a recipient's task list, etc. The recipient may have the option to accept or decline meetings or tasks. Beneficially, the systems and methods of the present invention allow lists of messages, meeting lists, and task lists generated by the process management application 12 to be integrated with those generated independent of the process management application 12. It should be noted that the message handlers 14 may be used in conjunction with any mail client system 30 which supports email, scheduling, and tasking.

The message handlers 14 are also operable for attaching business object information to incoming messages 18 and outgoing messages 16 such that the process management application 12 may identify and update the appropriate business objects, presenting up-to-date information to remote users querying the globally-accessible system. This threading process may involve associating a message with the appropriate business object or associating a message with a prior message in the case of a reply. In general, when a business object is created, identifying information about the business object and a message itself are sent with the message via the message handler 14. Messages may be viewed as they relate to business objects, as well as to related messages. Advantageously, the threading process allows relevant information to be attached to messages, allowing, for example, the history of messages to be tracked.

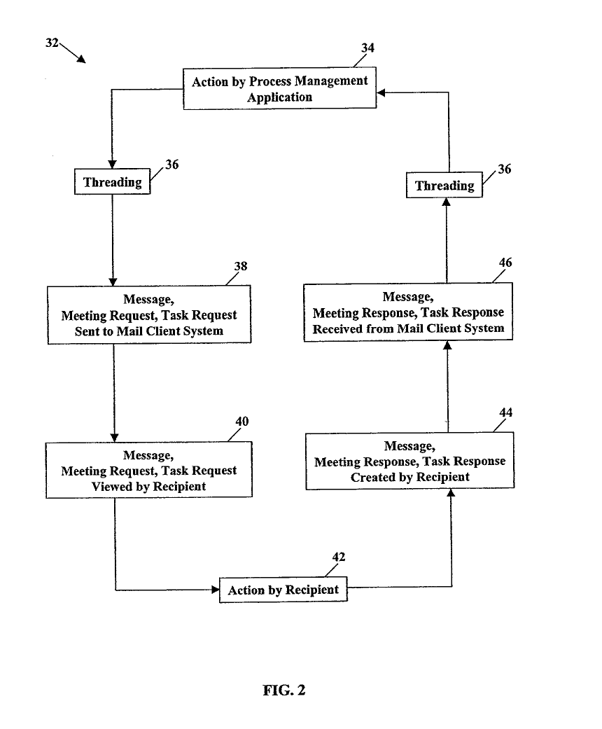

Referring to FIG. 2, in one embodiment, a computerized method 32 for acquiring and disseminating process management information includes the generation of a message or request 34 by the process management application 12 (FIG. 1). This message or request, which may be, for example, a meeting request or task request, may be threaded 36 by the process management application 12 and sent 38 to the mail client system 30 (FIG. 1). The message, meeting request, or task request may then be viewed 40 by a recipient. After an appropriate action 42 by the recipient, a message, meeting response, or task response may be created 44 by the recipient. This message, meeting response, or task response may then be sent via the mail client system 30 and received 46 by the process management application 12. The process management application may then take appropriate action 34 given the nature or content of the message, meeting response, or task response.

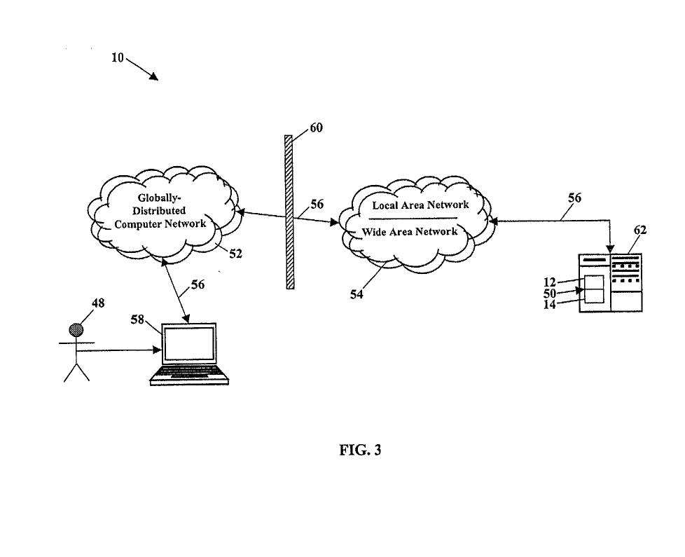

Referring to FIG. 3, in one embodiment, a computerized system 10 for acquiring and disseminating process management information includes a remote user 48 linked to a process management web page 50 via a globally-distributed computer network 52, such as the Internet or an intranet, and/or a local area network/wide area network (LAN/WAN) 54. This link may be established along one or more data communication lines 56, or via wireless interfaces. The remote user 48 may view, submit, and query information at the process management web page 50 through a browser application run by a computer 58, such as a desktop or laptop personal computer. Through the process management web page 50, the remote user 48 is linked, through a firewall 60, to a process management application 12 and one or more message handlers 14 which operate on process-related data. The process management web page 50 may reside in a persistent storage device 62, such as an application server, a web server, a file server, or a database server. The system 10 is set up such that the server 62 may communicate information to and acquire information from a plurality of remote users 48 simultaneously.

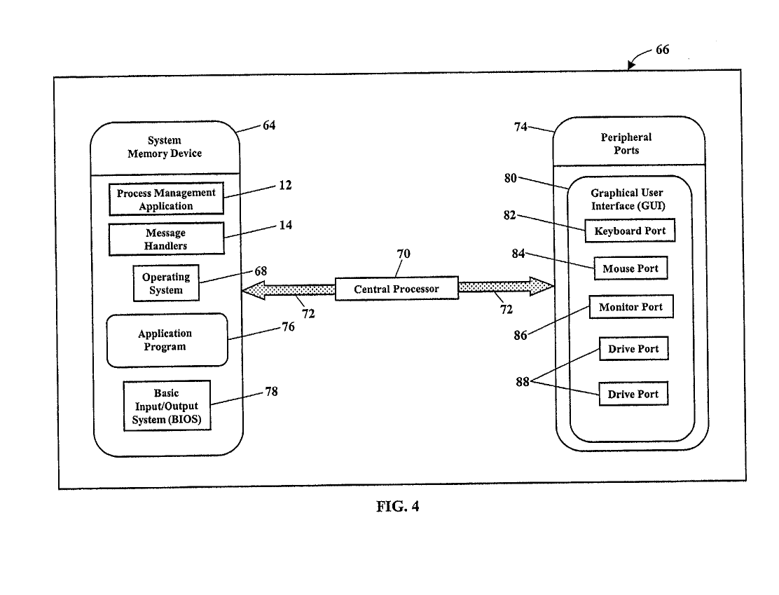

Referring to FIG. 4, in one embodiment, the process management application 12 and the message handlers 14 comprise one or more computer programs which acquire process-related data, store and archive the data, manipulate the data, and formulate outputs which may be viewed and queried by the remote user 48 (FIG. 3). The process management application 12 and the message handlers 14 preferably reside within the system memory device 64 of a computer system 66, which may, optionally, be an application server, a web server, a file server, or a database server. The system memory device 64 may include a random-access memory (RAM) and a read-only memory (ROM). The system memory device 64 may also include other types of memory, such as programmable read-only memory (PROM), erasable programmable read-only memory (EPROM), and electrically erasable programmable read-only memory (EEPROM). The system memory device 64 also preferably includes an operating system 68 that executes on a central processor 70. The central processor 70 may be, for example, a microprocessor. Suitable examples of microprocessors include, but are not limited to, those manufactured by Advanced Micro Devices, Inc. (Sunnyvale, Calif.), Intel Corporation (Santa Clara, Calif.), Motorola, Inc. (Schaumburg, Ill.), International Business Machines Corp. (Armonk, N.Y.), and Transmeta Corp. (Santa Clara, Calif.). The central processor 70 may include an arithmetic logic unit (ALU), which performs arithmetic and logic operations, and a control unit, which extracts instructions from the system memory device 64. The operating system 68 may include a set of instructions which control the internal functions of the computer system 66. For example, the operating system 68 may recognize input from input devices, send output to output devices, keep track of directories and files, and control various peripheral devices. Suitable examples of operating systems 68 include, but are not limited to, those manufactured by Microsoft Corporation (Redmond, Wash.) and Apple Computer, Inc. (Cupertino, Calif.). A system bus 72 may communicate signals, such as address signals, data signals, and control signals, between the system memory device 64, the central processor 70, and one or more peripheral ports 74. The system memory device 64 may also contain an application program 76 and a basic input/output system (BIOS) 78. The application program 76 cooperates with the operating system 68 and the one or more peripheral ports 74 to provide a graphical user interface (GUI) 80. The GUI 80 typically includes a combination of signals communicated along a keyboard port 82, a mouse port 84, a monitor port 86, and one or more drive ports 88. The BIOS 78 may interpret requests from the operating system 68 and interface with such ports to execute the requests. Accordingly, suitable input/output devices include a keyboard, a mouse, a monitor, a printer, a plotter, speakers, etc.

The systems, methods, programs, and processes described in relation to the present invention are not limited to any particular computer system 66. The computer system 66 may be a single device, or it may be a plurality of devices working in concert. The computer system 66 may take the form of a hand-held digital computer, a personal computer, a workstation, a server, a mainframe computer, and a supercomputer.

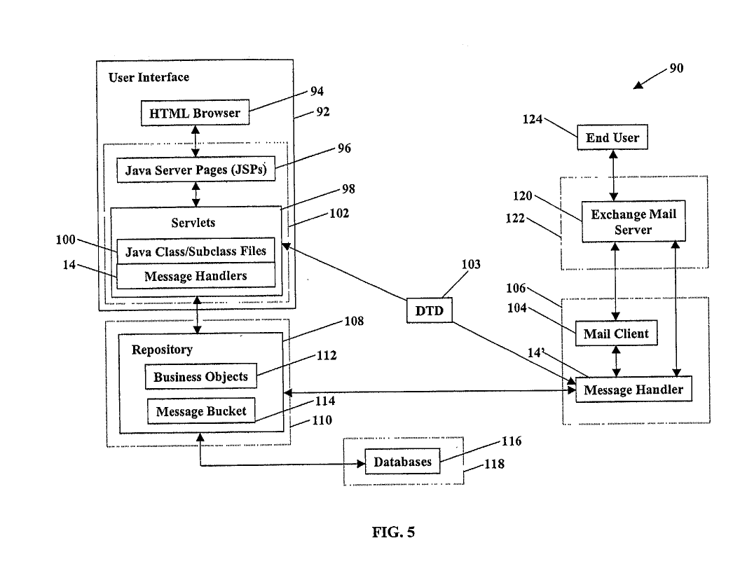

Referring to FIG. 5, in one embodiment, a system architecture 90 for the system 10 (FIGS. 1 and 3) for acquiring and disseminating process management information includes a user interface 92 operable for sending messages to and receiving messages from an external mail client system. The user interface 92 may include, for example, a hypertext markup language (HTML) browser 94 in communication with a plurality of Java server pages (JSPs) 96 and a plurality of servlets 98. The plurality of servlets 98 may include a plurality of Java class/subclass files 100 and one or more message handlers 14. The message handlers 14 may include, for example, a generic message handler, operable for creating/reading extensible markup language (XML) messages, and an application message handler, operable for creating/reading project specific messages and attaching business objects to such messages. The JSPs 96, servlets 98, Java class/subclass files 100, and message handlers 14 may be disposed within a first UNIX box 102. The user interface 92, and specifically the servlets 98, are preferably in communication with an external message handler 14″ and a mail client 104. The external message handler 14″ may be, for example, a generic message handler, operable for creating/reading XML messages. The external message handler 14″ and the mail client 104 may be disposed within a first NT box 106. A Document Type Definition (DTD) is preferably used to operably link the servlets 98 to the external message handler 14″, allowing information, i.e. messages, to be transmitted between the user interface 92 and the external mail client system. The DTD may be contained in a <!DOCTYPE> tag, contained in an external file and referenced from a <!DOCTYPE> tag, or both. The user interface 92, and specifically the servlets 98, may also be in communication with a repository 108, which may be disposed within a second UNIX box 110. The repository 108 may include business object information 112 and a message bucket 114 for temporarily storing XML messages. The repository 110 may also be in communication with a plurality of internal or external databases 116, which may disposed within a third UNIX box 118. The external message handler 14″ and the mail client 104 are preferably in communication with an exchange mail server 120, which may be disposed within a second NT box 122. An end user 124 is preferably in communication with and utilizes the exchange mail server 120 to send and receive XML messages.

It should be noted that XML, as used herein, is a meta-language which may be used to describe a broad range of hierarchical markup languages. It defines a set of rules, guidelines, and conventions for describing structured data in a plain text, editable file.

It is apparent that there has been provided, in accordance with the present invention, web-based systems and methods for acquiring and disseminating process management information using an external mail client system. While the present invention has been particularly shown and described in conjunction with examples and preferred embodiments thereof, it will be appreciated that variations in and modifications to the present invention may be effected by persons of ordinary skill in the art without departing from the spirit or scope of the present invention. For example, the computerized systems and methods of the present invention may be used for assuring process compliance for a wide array of processes, not simply those related to new product introductions. Further, the computerized systems and methods of the present invention may be used for allowing any web-based application to send messages to and receive messages from a plurality of remote users via an external mail client system, not simply a project or process management application. It is to be understood that the principles described herein apply in a similar manner, where applicable, to all examples and preferred embodiments.

1. A computerized system for acquiring and disseminating information using a mail client system, the system for acquiring and disseminating information comprising:
an application operable for generating and incorporating a plurality of messages;
one or more message handlers in communication with the application and the mail client system, the one or more message handlers operable for attaching identifying information to each of the plurality of messages;
a definition operable for translating each of the plurality of messages such that each of the plurality of messages may be understood by the one or more message handlers; and
a communications network operable for transmitting each of the plurality of messages between the application, the one or more message handlers, and the mail client system.

2. The system of claim 1, wherein each of the plurality of messages are related to any of project tollgates, project activities, project tasks, project issues, project risks, and project meetings associated with the management of a process.

3. The system of claim 1, wherein the one or more message handlers are operable for attaching business object information to each of the plurality of messages.

4. The system of claim 1, wherein the one or more message handlers are operable for attaching information regarding related prior messages to each of the plurality of messages.

5. The system of claim 1, wherein the communications network comprises a globally-distributed computer network.

6. The system of claim 5, wherein the communications network further comprises a local area network (LAN).

7. The system of claim 5, wherein the communications network further comprises a wide area network (WAN).

8. The system of claim 1, wherein the definition interfaces the one or more message handlers by describing syntax in a common extensible markup language (XML) format.

9. A computerized system for acquiring and disseminating process management information, the system comprising:
a process management application operable for generating and incorporating a plurality of messages, wherein each of the plurality of messages are related to any of project tollgates, project activities, project tasks, project issues, project risks, and project meetings;
a mail client system operable for generating and incorporating a plurality of messages, wherein each of the plurality of messages are related to any of project tollgates, project activities, project tasks, project issues, project risks, and project meetings;
one or more message handlers in communication with the process management application and the mail client system, the one or more message handlers operable for attaching identifying information to each of the plurality of messages;
a definition operable for translating each of the plurality of messages such that each of the plurality of messages may be understood by the one or more message handlers; and
a communications network operable for transmitting each of the plurality of messages between the process management application, the one or more message handlers, and the mail client system.

10. The system of claim 9, wherein the one or more message handlers are operable for attaching business object information to each of the plurality of messages.

11. The system of claim 9, wherein the one or more message handlers are operable for attaching information regarding related prior messages to each of the plurality of messages.

12. The system of claim 9, wherein the communications network comprises a globally-distributed computer network.

13. The system of claim 12, wherein the communications network further comprises a local area network (LAN).

14. The system of claim 12, wherein the communications network further comprises a wide area network (WAN).

15. The system of claim 9, wherein the definition interfaces the one or more message handlers by describing syntax in a common extensible markup language (XML) format.

16. A computerized method for acquiring and disseminating information using a mail client system, the method for acquiring and disseminating information comprising:
generating and receiving a plurality of messages;
attaching identifying information to each of the plurality of messages;
translating each of the plurality of messages such that each of the plurality of messages may be understood by one or more message handlers; and
transmitting each of the plurality of messages between an application, the one or more message handlers, and the mail client system using a communications network.

17. The method of claim 16, wherein attaching identifying information to each of the plurality of messages further comprises attaching business object information to each of the plurality of messages.

18. The method of claim 16, wherein attaching identifying information to each of the plurality of messages further comprises attaching information regarding related prior messages to each of the plurality of messages.

19. The method of claim 16, wherein the communications network comprises a globally-distributed computer network.

20. The method of claim 19, wherein the communications network further comprises a local area network (LAN).

21. The method of claim 19, wherein the communications network further comprises a wide area network (WAN).

22. The method of claim 16, wherein translating each of the plurality of messages such that each of the plurality of messages may be understood by one or more message handlers further comprises interfacing the one or more message handlers by describing syntax in a common extensible markup language (XML) format.

23. A computerized method for acquiring and disseminating process management information using a mail client system, the method for acquiring and disseminating process management information comprising:
generating and receiving a plurality of messages related to any of project tollgates, project activities, project tasks, project issues, project risks, and project meetings;
attaching identifying information to each of the plurality of messages;
translating each of the plurality of messages such that each of the plurality of messages may be understood by one or more message handlers; and
transmitting each of the plurality of messages between a process management application, the one or more message handlers, and the mail client system using a globally-distributed computer network.

24. The method of claim 23, wherein attaching identifying information to each of the plurality of messages further comprises attaching business object information to each of the plurality of messages.

25. The method of claim 23, wherein attaching identifying information to each of the plurality of messages further comprises attaching information regarding related prior messages to each of the plurality of messages.

26. The method of claim 23, wherein the globally-distributed computer network further comprises a local area network (LAN).

27. The method of claim 23, wherein the globally-distributed computer network further comprises a wide area network (WAN).

28. The method of claim 23, wherein translating each of the plurality of messages such that each of the plurality of messages may be understood by one or more message handlers further comprises interfacing the one or more message handlers by describing syntax in a common extensible markup language (XML) format.
